(19) United States
(12) Patent Application Publication
(10) Pub. No.: US 2015/0009669 A1
(43) Pub. Date: Jan. 8, 2015

(54) LIGHT ELEMENT

(71) Applicant: FRED & FRED, Lille (FR)

(72) Inventors: Frédéric Gervais, Montreuil (FR); Frédéric Remaud, Lille (FR)

(21) Appl. No.: 14/363,234

(22) PCT Filed: Dec. 12, 2012
(86) PCT No.: PCT/FR2012/052807

§ 371 Date: Jun. 5, 2014

(30) Foreign Application Priority Data
Dec. 5, 2011 (FR) 1161161

(51) Int. Cl. F21V 5/04; F21K 99/00

(52) U.S. Cl. CPC F21V 5/04; F21K 9/50; F21Y 2101/02
USPC 362/244

(57) ABSTRACT

Light device comprising a panel (1) having at least two lenses (2) , each of the lenses comprising a non-planar first surface provided on a first face of the panel and a second surface provided on a second face of the panel, the first face and the second face of the panel being positioned facing one another, the light device also comprising a set of n light sources (4), n being greater than or equal to 1, the light sources being positioned in the vicinity of the second face.

The present invention relates to a luminous element intended for the production of products such as interior and exterior dividers, removable dividers, single walls, curtain walling for facades, communicating elements, ceilings, suspended ceilings, floor tiles, glazing units, doors, windbreaks, latticed screens, lighting devices and luminous partitions.

The invention is particularly suitable for architectural and interior lighting, and for the production of pieces of furniture.

Creative effort in the sector concerned with the lighting of architectural spaces has become oriented towards solutions in which light is guided, attenuated or scattered. To do this, thin-film type treatments have been used on glass to attenuate or modify the spectral distribution of light. Another method employed to attenuate light is to use the electromagnetic properties of light waves—light panels exploit the polarisation of light using polarising filters and the birefringence of certain nematic-phase liquid crystals, the orientation of which may be varied with an electric field.

These complex devices are very expensive and sometimes present problems with aging or their behavior as a function of the temperature of their surroundings or in the presence of moisture. Their use as architectural elements in the erection of partitions is not possible.

EP 1 866 495 describes a construction element, for use in the erection of partitions making it possible to see without being seen, comprising at least one lens and a screen.

The device provided achieves the targeted objective but has a substantial thickness. Moreover, it is not a lighting element.

The aim of the invention is above all to provide a

device having enough strength to allow it to be used as a panel in an architectural assembly while having luminous properties allowing it to be used as a luminous panel. Furthermore, said device makes it possible to provide lighting while preserving the transparency of the assembly.

A luminous device according to the invention is characterized in that it comprises an array of lenses, said array having a first non-planar face containing at least one recess with a curvature change, and a second face, the first face and the second face being placed facing, the luminous device also comprising an array of light sources, each light source being placed on an axis orthogonal to the second face and passing through a recess in the first face.

The recess will most often have a V shape. The recess may be linear and located between two lenses but the recess may also foe located in the vicinity of a point of contact between several lenses. Surprisingly, it has been observed that by proceeding in this way light emitted by the light source is better scattered and the dazzle of the device for an observer looking toward it is thereby also decreased.

Moreover, by placing the light sources and their electrical supply cables in the vicinity of the junction between two lenses, the structure supporting the light sources and the cables cannot be seen by an observer located in front of the device if, for example, a grid-shaped supporting structure is used.

It is therefore possible to produce a device that is transparent but that also generates light. The light source may be an LED source, an OLED source or any other type of source.

The device may comprise an array of lenses, said array comprising a first face and a second face, the first face and the second face being placed facing, the luminous device also comprising an array of light sources, each light source being placed on an axis orthogonal to the second face and passing in the vicinity of the center of the first face, the second face having at least one roughened zone forming a screen.

At least one image may be created by at least one lens, said image being visible to an observer facing the first face of the panel.

Advantageously, the first face and the second face of the panel are parallel, but it is also possible to use a second face that is slightly inclined relative to the first face in order, for example, to orient the light flux in a given direction.

Each lens may have an optical axis, the optical axis of the lens p being parallel to the optical axis of the lens p+1, whatever the value of p.

As a variant, each lens may have an optical axis, the optical axes of the lenses being such that an image is visible to an observer facing the first face of the panel, in at least two different positions of said observer.

Advantageously, at least one of the lenses is concave.

The lens may have a focal plane such that the image of an object located beyond the second face forms a virtual image located in front of the second face for an observer facing the first face.

The first face may comprise at least three concave-shaped zones placed contiguously, a space forming a point existing between the three zones.

The first face may comprise four concave-shaped zones placed contiguously, a space forming a point existing between the three zones.

In the latter case, the point is advantageously flattened to form a plane.

At least one lens may comprise, on at least one of its faces, a surface treatment, such as a roughened surface or at least one deposited thin film.

The second face is advantageously planar. This feature especially makes it easier to produce the panel by laminating.

At least one of the edge faces of the panel may have a mirror finish or be coated with deposited thin films. The layers used may have antireflection, color-selecting, or polarising properties. The layers used range from a few nanometers to a few microns in thickness.

The panel may also foe formed from two component panels securely fastened together by a fastening means.

The light source may be located between two panels. In this case, the two panels may be laminated.

The device may comprise an alternation of light sources of different colors. It thus becomes possible, if for example red, green and blue, or white, blue and red light sources are used, to produce light the color of which varies depending on the intensity emitted by the various light sources. Such a device may be used in light therapy.

The invention also relates to a process for producing a panel such as described above, the planes formed by flattening allowing the panel to be laminated.

In this case, a spacer may be inserted making contact with the planes formed by flattening before a laminating operation.

Other embodiments are illustrated in the appended drawings, but they in no way limit the scope of the invention. In these figures:

FIG. 1 is a schematic perspective view of a first embodiment of a device according to the invention;

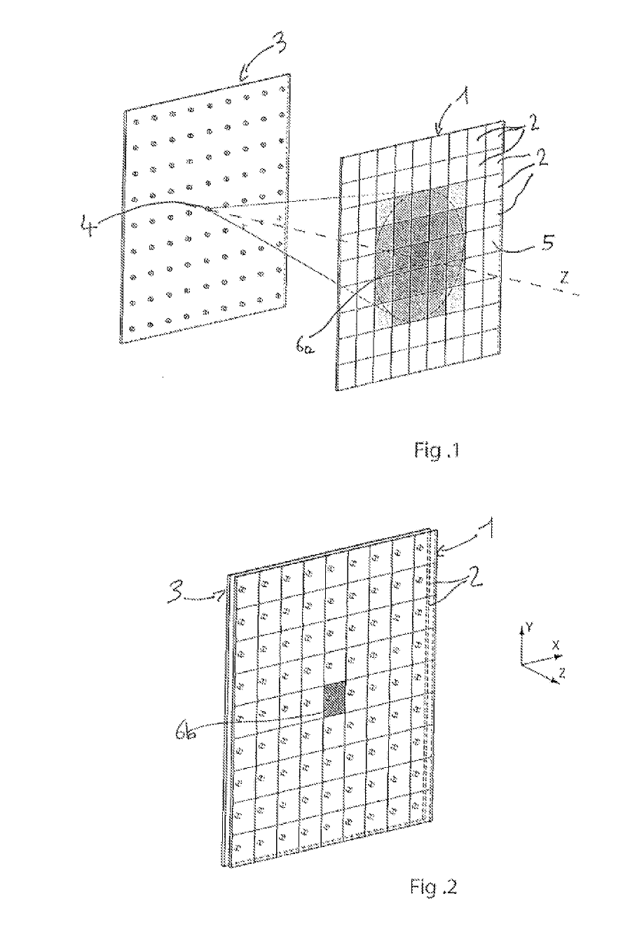

FIG. 2 is a perspective view of another embodiment;

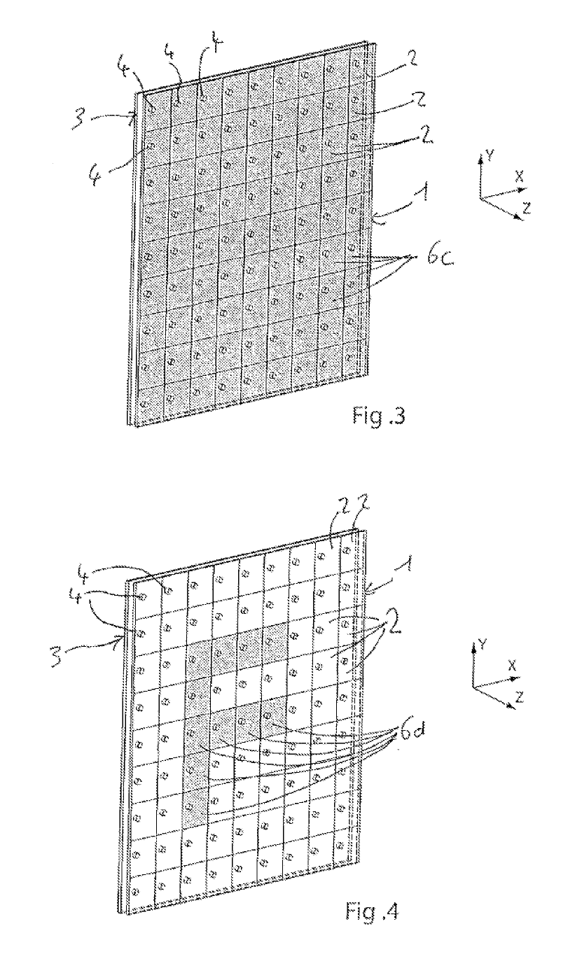

FIG. 3 is a similar view to FIG. 2, of another embodiment;

FIG. 4 is a similar view to FIG. 2, of another embodiment;

FIG. 5 is a cross-sectional view of one embodiment ending to the invention;

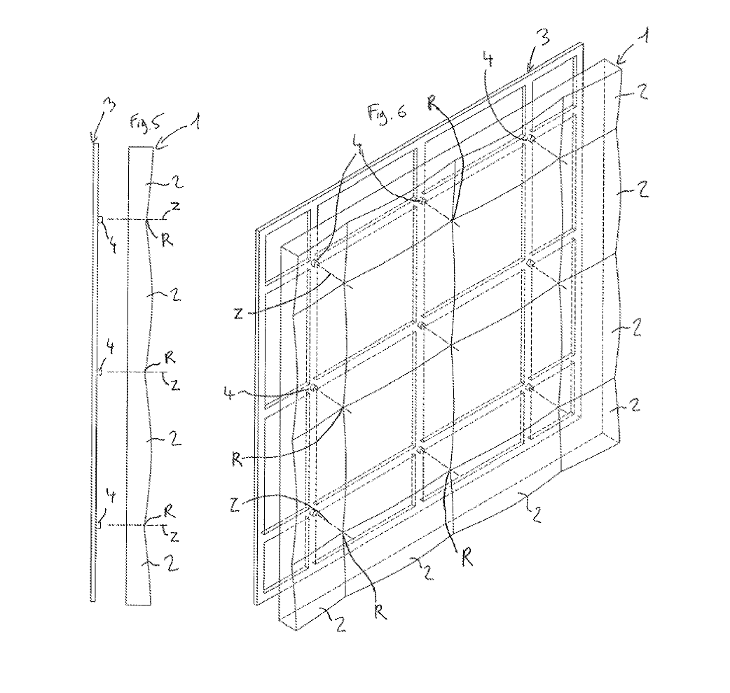

FIG. 6 is a perspective view of the device in FIG. 5;

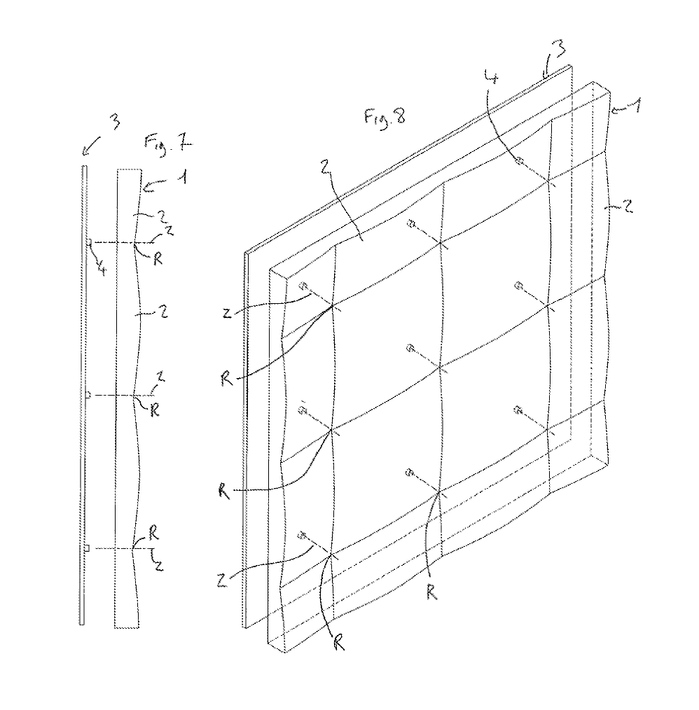

FIG. 7 is a cross-sectional view of one embodiment of a device according to the invention;

FIG. 8 is a perspective view of the device in FIG. 7;

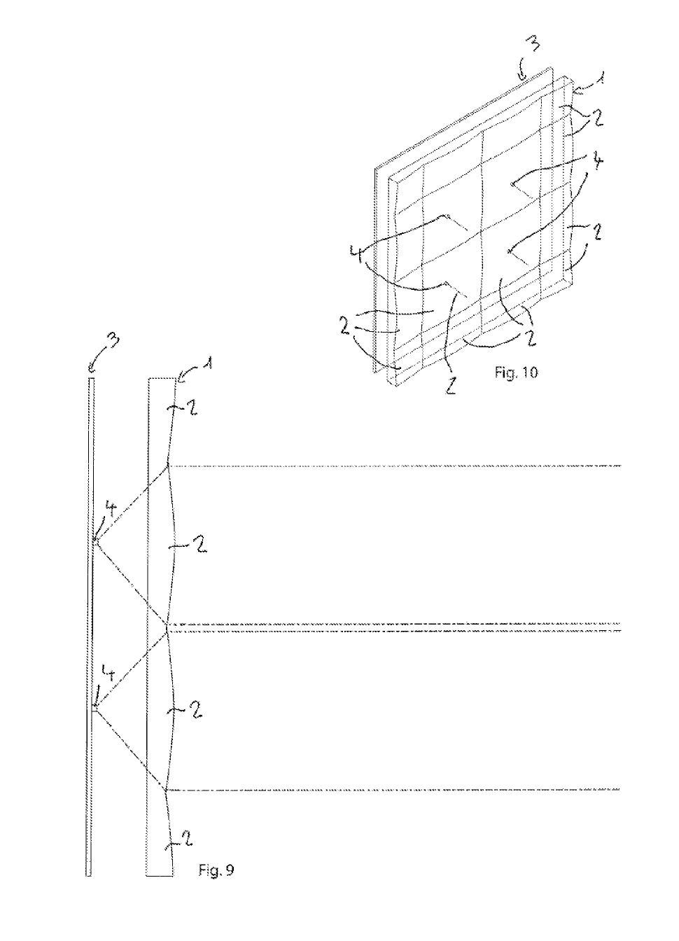

FIG. 9 is a cross-sectional view illustrating the production of images on the second face;

FIG. 10 is a perspective view of the device in FIG. 9;

FIG. 11 is a similar view to FIG. 5 illustrating the use of hexagonal lenses;

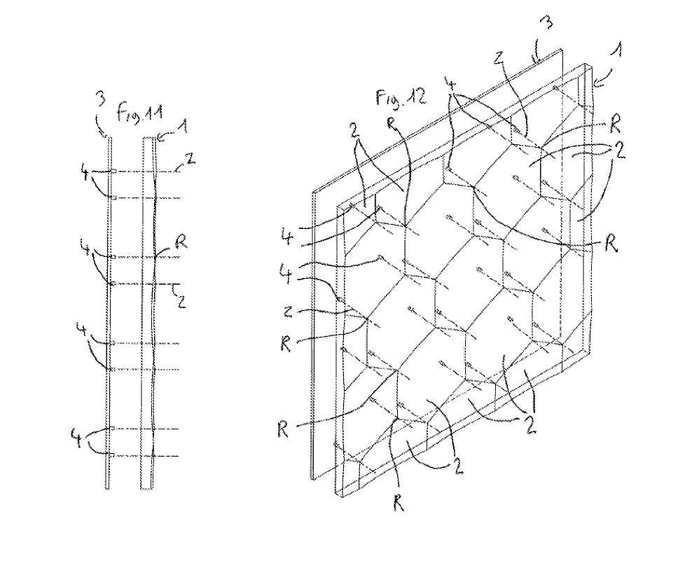

FIG. 12 is a perspective view of the device in FIG. 11;

FIG. 13 is a similar view to FIG. 5 illustrating the use of a glass panel of constant thickness;

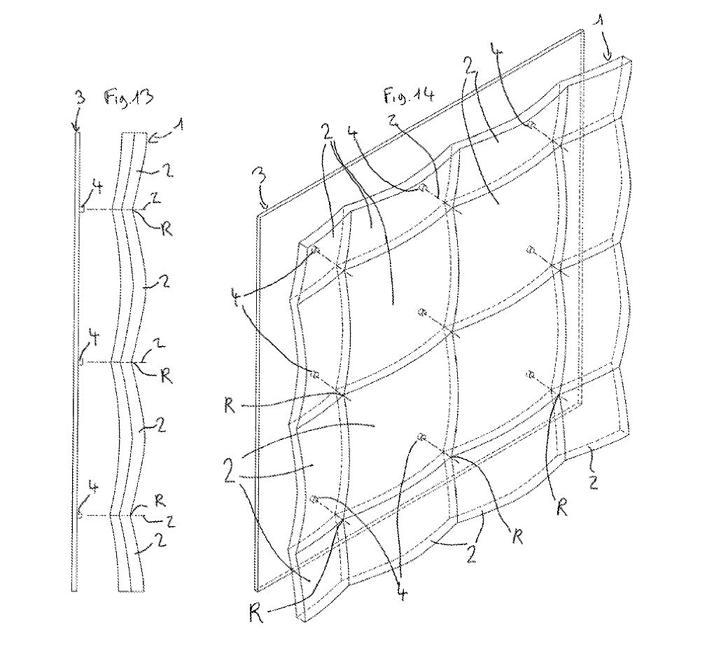

FIG. 14 is a perspective view of the device in FIG. 13;

FIG. 15 is a similar view to FIG. 5 illustrating the use of groups of lenses covering only part of the surface of the device;

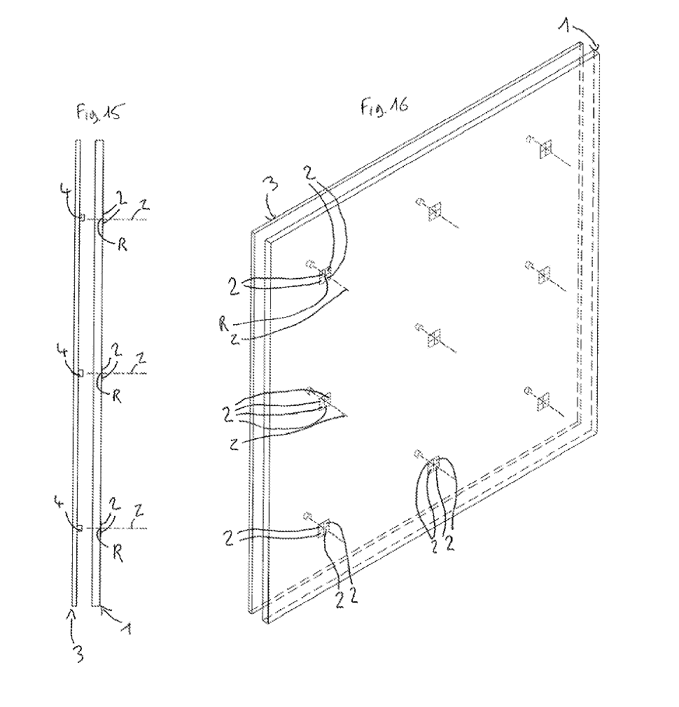

FIG. 16 is a perspective view of the device in FIG. 15;

FIG. 17 is a perspective view of a lens containing a recess;

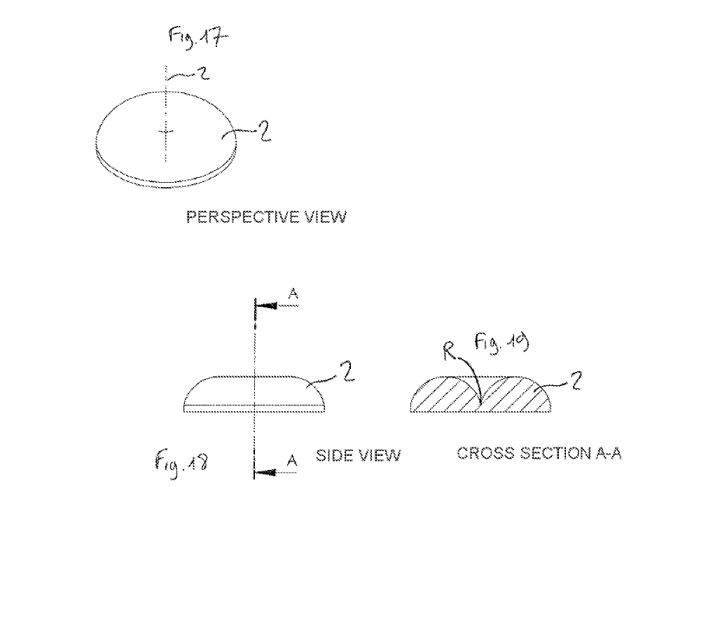

FIG. 18 is a side elevation of the device in FIG. 17; and

FIG. 19 is a cross-sectional view of the device in FIG. 17.

The device allows a matrix of images seen by the eye of the observer to foe created in order to animated an architectural or urban space visually while advantageously providing a light source.

The first embodiment of the invention relates to the production of luminous partitions such as, for example, luminous dividers or ceilings, comprising a plane 1 composed of an array of n square convex lenses 2, n being higher than or equal to 2. A second plane 3, parallel to the plane 1, comprises an LED light source 4 is provided for backlighting along a propagation axis (Z) orthogonal to the first face 5 of the plane 1 containing the lenses 2.

The effect obtained in the eye of the observer is a matrix of images of the emitted light, taking the form of a luminous square 6a in the center of the plane 1, the emitted light spreading, depending on the light intensity, to produce squares on the optical plane (FIG. 1).

Case 2: the effect obtained in the eye of the observer is a luminous square 6b, depending on the intensity of the light and the distance between the plane 1 and the plane 3 comprising the light source ( FIG. 2).

The second embodiment of the invention relates to the production of luminous partitions such as luminous dividers or ceilings providing diffuse light, comprising a plane 1 composed of an array of n square convex lenses 2, n being higher than or equal to 2. A parallel second plane 3 comprises n LED light sources 4, n being higher than or equal to 2, which provide backlighting along a propagation axis (Z) located on the optical axis of each lens 2 making up part of the optical plane.

The effect obtained in the eye of the observer is a matrix of images of the light, taking the form of n luminous squares 6c, n being equal to the number of lenses in the plane 1 (FIG. 3).

The third embodiment of said invention relates to the production of luminous partitions, such as luminous dividers or ceilings, emitting diffuse light and the objective of which is to provide illumination in all directions.

Such a partition comprises a plane composed of an array of n square convex lenses, n being higher than or equal to 2. Each of the lenses having a nonparallel optical axis. The device also comprises a second plane parallel to the first plane and comprising n LED light sources, n being higher than or equal to 2, which provide backlighting along a propagation axis (Z), each lens making up part of the optical plane.

The effect obtained in the eye of the observer is a matrix of images of the light, taking the form of n luminous squares, n being equal to the number of lenses oriented in the various directions, such that whatever the location of the observer the latter sees a light source.

The fourth embodiment of a device according to the invention is intended for the production of luminous partitions, such as luminous dividers or ceilings. The device comprises a plane 1 composed of an array of n square convex lenses 2, n being higher than or equal to 2. A second plane 3, parallel to the first plane, comprises n LED light sources 4 arranged in a pattern and illuminating, along a propagation axis (Z), the plane formed by the lenses.

The effect obtained in the eye of the observer is

a pattern made up of variations in light intensity and taking the form of n luminous squares 6d in the center of the optical partition, the emitted light spreading along the (X) and (Y) axes (FIG. 4).

Many variants of the embodiments described above are possible.

The first face may comprise planar, concave, biconcave, convex or biconvex zones.

The second face may comprise concave, biconcave, convex or biconvex shapes or even foe planar.

The first face may without preference be composed of various image-creating optical shapes.

The optical panel many be molded but also produced using a glass texturing technique or a bending technique. The panel is placed on its first face. Adding positioning shims, ideally located between the lenses, makes it possible to distribute strains generated when the transparent panel is loaded and friction generated in the operations, such as decoration, lamination and cutting operations, used to transform the glass.

The fact that the light sources 4 are no longer placed in the vicinity of the optical axis of the lens 2, as was the case in the prior art, but rather on an axis orthogonal to the second face and passing through a recess R in the first face, allows the light emitted by the light source 4 to be better scattered and to prevent an observer looking in the direction of the device from being dazzled.

FIGS. 5 to 19 illustrate a number of embodiments allowing this effect to be obtained.

FIGS. 9 and 10 illustrate an embodiment in which the light sources 4 are ideally placed on the object focal plane in order to project light and form an image on the second face if the latter is roughened.

Many different effects may be obtained by adjusting the shape of the lenses 2. Moreover, it is also possible to use groups of lenses 2 located only in certain locations on a supporting panel, as illustrated in FIGS. 15 and 16. It then becomes possible to produce embossed patterns or letters allowing luminous text to be displayed.

It is also possible to use light sources 4a, 4b, 4c of different colors, see FIG. 21.

Lastly, with regard to miniaturization, it may also be envisioned to use a single lens having a specific shape, as illustrated in FIGS. 17 to 19. The shape of the lens is then a half horn torus, thereby allowing the recess R to be obtained, opposite which recess the light source 4 will be placed.

1. A luminous device comprising: an array of lenses (2), said array having a first non-planar face containing at least one recess (R) with a curvature change, and a second face, the first face and the second face being placed facing, the luminous device also comprising an array of light sources, each light source (4) being placed on an axis (Z) orthogonal to the second face and passing through a recess in the first face, a space separating the second face from the light source.

2. The luminous device as claimed in claim 1, wherein the recess (R) is linear and located between two lenses (2).

3. The luminous device as claimed in claim 2, wherein the recess is located in the vicinity of a point of contact between several lenses.

4. A. luminous device comprising: an array of lenses (2), said array comprising a first face and a second face, the first face and the second face being placed facing, the luminous device also comprising an array of light sources, each light source (4) being placed on an axis orthogonal to the second face and passing in the vicinity of the center of the first face, the second face having at least one roughened zone forming a screen.

5. The luminous device as claimed in claim 1, wherein at least one image is created by at least one lens, said image being visible to an observer facing the first face of the panel.

6. The luminous device as claimed in any claim 1, wherein the first face and the second face of the panel are parallel.

7. The luminous device as claimed in claim 1, wherein each lens has an optical axis, the optical axis of the lens p being parallel to the optical axis of the lens p+1, whatever the value of p.

8. The luminous device as claimed in claim 1, wherein each lens has an optical axis, the optical axes of the lenses being such that an image is visible to an observer facing the first face of the panel in at least two different positions of said observer.

9. The luminous device as claimed in claim 1, wherein at least one of the lenses is concave.

10. The luminous device as claimed in claim 8, that wherein the lens has a focal plane such that the image of an object located beyond the second face forms a virtual image located in front of the second face for an observer facing die first face.

11. The luminous device as claimed in claim 1, wherein the first face comprises at least three concave-shaped zones placed contiguously, a space forming a point existing between the three zones.

12. The luminous device as claimed in claim 1, wherein the first face comprises four concave-shaped zones placed contiguously, a space forming a point existing between the three zones.

13. The luminous device as claimed in claim 12, wherein the point is flattened to form a plane.

14. The luminous device as claimed in claim 1, wherein at least one lens comprises, on at least one of its faces, a surface treatment, such as a roughened surface or at least one deposited thin film.

15. The luminous device as claimed in claim 14, wherein at least one portion of the surface of the lens a surface treatment, such as a roughened surface or at least one deposited thin film.

16. The luminous device as claimed in claim 1, wherein the second face is planar.

17. The luminous device as claimed in claim 1, wherein at least one of the edge faces of the panel has a mirror finish or is coated with deposited thin films.

18. The luminous device as claimed in claim 1, wherein the panel is formed from two component panels securely fastened together by a fastening means.

19. The luminous device as claimed in claim 1, wherein the light source is located between two panels.

20. The luminous device as claimed in claim 19, wherein the two panels are laminated.

21. A process for obtaining a panel as claimed in claim 13, wherein the planes formed by flattening allow the panel to be laminated.

22. The process as claimed in claim 21, wherein a spacer is inserted making contact with the planes formed by flattening before a laminating operation.

23. The luminous device as claimed in claim 1, wherein the device comprises an alternation of light sources of different colors.
